(19) United States
(12) Patent Application Publication
(10) Pub. No.: US 2005/0173258 A1
(43) Pub. Date: Aug. 11, 2005

(54) Method for electrolytic polishing of dental instruments made of nickel-titanium alloy

(76) Inventors: Francois Aeby, Montagny-Pres-Yverdo (CH); Bertrand Kempf, Katyenthal (FR)

Correspondence Address: DENTSPLY INTERNATIONAL INC, 570 WEST COLLEGE AVENUE, YORK, PA, 17404, US

(21) Appl. No.: 10/521,726

(22) PCT Filed: Jul. 8, 2003
(86) PCT No.: PCT/IB03/03135

(30) Foreign Application Priority Data
Jul. 17, 2002 (EP) 02015895.2

(51) Int. Cl. B23H 3/00

(52) U.S. Cl. 205/640; 205/678

(57) ABSTRACT

The subject of the present invention is an electrolytic polishing process for dental instruments of nickel-titanium alloy using an electrolyte comprising sulfuric acid and methanol. The electricity is supplied by applying a current, the current density being regulated so that it remains constant.

The subject of the present invention is an electrolytic polishing process for dental instruments of nickel-titanium alloy using an electrolyte comprising sulfuric acid and methanol.

Dental instruments used within the scope of a root treatment are generally made of stainless steel, but also of nickel-titanium alloy. These alloys offer interesting performances in terms of flexibility and respect of the canal trajectory. However, instruments produced with these latter alloys have somewhat rough surface states after machine-grinding. These surface states combine certain conditions sufficient for the creation of microscopic cracks which can, under the effect of a repeated cyclic movement during an operation in a curved canal, induce a propagation of cracks until the instrument breaks. This risk presents a major disadvantage of these dental instruments for the work of the dentist as well as for the manufacturer of the instruments. A surface treatment by a planing of these irregularities permits extending the service life of the dental instrument by reducing the propagation rate of the cracks. Instruments for the treatment of dental root canals often have a complex geometry, comprising, for example, a tapered shaft having over at least a part of its length, constituting its active part, a helical cutting edge. The choice among the different possibilities for surface treatments is thus limited by applicability to such a geometry.

Electrochemical polishing is a suitable solution and has been known for a long time as an effective means for conducting such a surface treatment, for steels, titanium and their alloys, as well as other materials. The approach used in order to determine, for example, the composition of the bath, the electrical supply system or other important components in an optimal manner, as a function of the desired results, is nevertheless relatively empirical. The search for optimal parameters for a new material to be treated or a new process for this purpose is thus often the subject of a series of experiments, since these parameters are not easily determined from calculations based on known processes.

Conventional electrolysis for the treatment of titanium up until the recent past made use of a bath composition based on perchloric acid or perchlorate, which poses problems due to the explosive nature of these substances. New electrolytes excluding the traditional usage of perchloric acid or perchlorate have been used in order to render electrolytic polishing of titanium and its alloys more industrially applicable, such as disclosed, for example, in the article “Electropolishing of titanium and titanium alloys in perchlorate-free electrolytes” (Plating and Surface Finishing—May 1998) of Messrs. D. Landolt, C. Madore and O. Piotrowski. Baths currently in use operate with methanol and sulfuric acid electrolytes. An example of a corresponding process is disclosed in the document WO 98/03702 which describes the surface treatment of layers of TiC, TiN or Ti(C,N) by immersing the pieces to be treated, among other materials, in a mixture of sulfuric acid and methanol and applying an electrical potential between a cathode and the parts to be treated.

A composition of the bath which is different in its precise proportions, but similar to that proposed in this document, is well suited to the treatment of nickel-titanium alloys due to the fact that these alloys have a layer of TiO₂ similar to pure titanium on the surface. However, such a process has a major disadvantage, in the sense that the parts to be treated by electrolysis must first be prepared by an emery board or by sanding of this surface. This preparation step involves additional costs which render the process uninteresting from an economic point of view; in addition to high production costs, the manufacturing time is increased and this additional step involves the risk of damaging the parts or mixing them up.

The object of the present invention is to create an electrolysis process for dental instruments of titanium-nickel alloy that eliminates the pre-cited disadvantages of the current processes by permitting the realization of such a process at a more appealing manufacturing cost, without the preparation step for the parts to be treated, thus increasing the production rate of the process while decreasing its possible inherent risks.

To this end, the process according to the present invention is characterized by the fact that electricity is supplied by applying a current, the density of which is regulated so that it remains constant.

Other advantages will appear in the characteristics expressed in the dependent claims and the description below disclosing the invention in more detail.

By reversing the electrical supply system for the electrolysis in a process according to the present invention, i.e., the voltage is made variable and the applied current density is kept constant, which is contrary to the usual case, and in a surprising manner, the result is notably obtained that any preliminary surface treatment of the parts to be treated is unnecessary.

By these measures, the obligatory preparation step within the framework of the usual process is thus no longer necessary for the new process and the additional costs are eliminated, permitting a much more appealing manufacturing cost than previously. In an advantageous manner, the manufacturing time is also shortened and the risk of damaging the parts or mixing them up is reduced.

In addition, the application of a current at constant density permits a significant lowering of the stirring rate of the parts in the electrolyte bath. Instead of a stirring rate of 200 mm/s as previously, the latter is situated for the new process at approximately 1 mm/s to 10 mm/s, facilitating the handling of the parts to be treated and sparing wear and tear on the automatic equipment used for conducting the electrolysis.

Moreover, by applying the novel process with an electrical supply by constant current density, one observes that the results of the surface treatment obtained with this method demonstrate a marked independence relative to the bath temperature. The new process thus facilitates and improves the surface treatment of nickel-titanium alloys, due to the fact that this independence is not present in the prior-art processes.

Such a configuration thus introduces considerable advantages in the electrolysis of dental instruments of nickel-titanium alloys and contributes to technical progress in this field.

The invention will now be described in detail by making reference, by way of example, to a form of execution of the process according to the present invention.

A process for electrolytic polishing of dental instruments of nickel-titanium alloys according to the present invention uses a mixture of sulfuric acid and methanol as the electrolyte. Preferably, the electrolyte is a mixture of methanol (CH₄O) and sulfuric acid (H₂SO₄) containing between 0.1 mole and 10 moles of sulfuric acid. The methanol is pure CH₄O, and the sulfuric acid used has a degree of purity of 96%. The electrolyte is manufactured by addition of sulfuric acid into methanol, the sulfuric acid concentration being within the margins indicated above. A good chemical homogeneity of the electrolyte solution can be obtained by leaving the mixture to stand for approximately three days.

Electricity is supplied by applying a current to the electrodes. The current density is regulated so that it remains constant. The cathode is formed by at least one electrode, for example of platinum, and the anode is formed by the parts to be treated, the electrolysis thus being conducted on the cathodic principle. A current regulation system permits monitoring and keeping constant the current density. Among other possibilities, this is possible by placing a reference electrode in the electrolyte, this reference electrode being connected to an ammeter designed to continuously measure current through the electrolyte. The current regulation system can thus use these data in order to maintain the current density at a predetermined value, for example, by means of a computer cooperating with said ammeter and assuring the application of a suitable current by the component providing the electrical supply. This value is preferably comprised between 10 A/dm² and 30 A/dm². Due to the fact that the current density is kept constant and the electrical resistance of the electrolyte varies during electrolysis since neither the composition of the bath nor that of the parts to be treated is stationary, the potential between the electrodes is therefore variable. For reasons of safety, the voltage can, however, be monitored in order not to surpass a voltage limit of 60 V, since higher values are judged dangerous for personnel. The fact that it is the current density and not the potential which is kept constant therefore constitutes an important difference of the electrolytic polishing process according to the present invention when compared with conventional processes.

For safety reasons, the entire electrolytic polishing process is carried out under circumstances permitting the bath temperature to be kept below 20° C. By means of a cryostat, for example, the temperature can be kept at the desired temperature, preferably 5° C.

Once the bath is prepared and the electricity is supplied in the manner described above, the parts to be treated are ready for electrolytic polishing. Notably, the parts, that is to say dental instruments of nickel-titanium alloys or some portions of them, do not undergo any specific treatment during a preparation step or a pretreatment before the electrolytic polishing, apart from a possible usual degreasing in a still bath. The parts to be treated are then immersed in the electrolyte. The duration of this immersion is situated between 10 s and 120 s. In the electrolyte, the parts are stirred at the given stirring rate, the movement being preferably made parallelly between the cathodes. The stirring rate for the parts can be low, approximately 1 mm/s to 10 mm/s, due to the use of a constant current density. After this step of polishing by electrolysis in the electrolytic bath, the parts are rinsed and dried, these steps corresponding to the usual process. Normally, the dental instrument parts to be treated in question are made of a titanium alloy containing at least 40% by mass of titanium, thus permitting the application of a process according to the present invention.

Thus, by reversing the electrical supply system for the electrolysis in an electrolytic polishing process for nickel-titanium alloys, i.e. by keeping constant the applied current density and by leaving the voltage variable, which is contrary to the usual case, one obtains the surprising effect of being freed from the need for any preliminary treatment of the surface of the parts to be treated.

1-6. (canceled)

7. An electrolytic polishing process for dental instruments of nickel-titanium alloy using an electrolyte, comprising:
providing an electrolyte including sulfuric acid and methanol; and
applying electricity having a current, density that is regulated so that it remains constant.

8. The process of claim 7, wherein said current density is between about 10 A/dm² and 30 A/dm².

9. The process of claim 7, wherein said electrolyte is a mixture of methanol and sulfuric acid, comprising between 0.1 mole and 10 moles of sulfuric acid.

10. The process of claim 7, wherein said electricity is supplied to a cathode and anode and wherein said cathode is formed by at least one platinum electrode and said anode is formed by said instruments to be treated.

11. The process of claim 7, wherein said instruments are stirred in said electrolyte at a stirring rate that is about 1 mm/s to 10 mm/s.

12. The process of claim 7, wherein said instruments to be treated are made of a titanium alloy having at least 40% by weight of titanium.
